(19) United States
(12) Patent Application Publication
(10) Pub. No.: US 2017/0130866 A1
(43) Pub. Date: May 11, 2017

(54) BALANCING VALVE

(71) Applicant: Zetkama Spolka z ograniczona odpowiedzialnoscia, Scinawka Sredina (PL)

(72) Inventors: Marcin Rogalka, Bystrzyca Klodzka (PL); Marcin Szpakowicz, Klodzko (PL); Andrzej Lisowski, Klodzko (PL)

(21) Appl. No.: 15/319,197

(22) PCT Filed: Jun. 9, 2015
(86) PCT No.: PCT/PL2015/000089

§ 371 Date: Dec. 15, 2016

(30) Foreign Application Priority Data
Jun. 18, 2014 (PL) P.408611

(51) Int. Cl. F16K 37/00; F16K 27/02; G01F 1/44; F16K 1/02

(52) U.S. Cl. CPC F16K 37/0016; F16K 1/02; F16K 27/02; G01F 1/44

(57) ABSTRACT

A balancing valve is usable to adjust and control the flow of fluid in central heating networks, hot and cold utility water installations and in air conditioning and cooling installations. The valve (1) has a body (2) with an inlet connector pipe (3) and an outlet connector pipe (4). A seat (5) is positioned in the body and an opening (20) in the body in alignment with the seat is closable with a releasible cover (12). A stem (7) is rotatable by a knob (10) relative to the cover. Rotational movement of the stem is operative to axially move a head (6) connected to an adjusting ring (13) relative to the seat within the valve. Exemplary valve components are comprised of plastics.

### TECHNICAL FIELD

Exemplary embodiments relate to balancing valves.

### BACKGROUND

Balancing valves are designed for adjustment and closing of the fluid flow in central heating networks, in hot and cold utility water installations, and in air conditioning and cooling installations.

An adjustment poppet valve is known that is formed of a body closed with a cover, and where a suitably shaped head on a stem cooperates with a seat of the valve.

The stem has a knob at one end and is guided in a threaded part in the cover where it is also sealed. The valve is provided with a scale that shows the positioning of the head relative to the seat. Usually, the scale shows the number of turns of the stem, from the state completely closed, and fraction(s) of one full turn.

An important issue in the construction of an adjustment valve is to obtain repeatability of a preset valve opening, so as to make the construction capable to close the valve when needed, and where re-opening is possible solely to a preset value.

Known balancing valves are provided with a head made of metal. Also such elements of the valve such as a body with inlet and outlet connector pipes, and a cover are made of metal. Most frequently, cast iron or non-ferrous metal alloys are used for this purpose. Components of the balancing valve made of these materials require precise mechanical shaping. Such heads are at the same time expensive in manufacturing due to both material costs, in particular non-ferrous metals costs, and treatment costs related first to casting a product and then to mechanical shaping thereof.

From the specification of the Polish patent application PL 215630 B1 a balancing valve is known, with a body that has two connector pipes. In the body a seat is housed, said seat being closed with a head mounted on a stem where the stem is seated in a gland. Outside the gland there is a knob connected to the stem. The valve is characterized in that the head is made of plastic and is connected to an adjustment ring which is made of plastics. The other elements of the valve, among others the body and a cover, are made of metal.

From the Polish utility model specification PL 66251 Y a head assembly of a balancing valve is known said valve being provided with a body which has an inlet connector pipe and an outlet connector pipe wherein in the body a closing seat is housed and the head is mounted on a stem where the stem is seated in a gland outside of which there is a knob connected to the stem. The head is made of plastics and the remaining elements of the valve, among others the body and a cover, are made of metal.

The valves which are made of metal are very susceptible to defects in precision of manufacture and even minor dimensioning defects may cause leakage at the contact area with the seat, and this is why in valves of this kind, equipped with metallic heads, it is necessary to use additional solutions to enhance sealing between the seat and the valve, involving for example resilient head suspension.

### SUMMARY

The balancing valve according an exemplary embodiment is provided with a body that has two connector pipes, i.e. an inlet connector pipe and an outlet connector pipe, said valve being closed with a cover. In the body a seat is housed and closed with a head mounted on a stem. The stem is seated in a gland arranged in the cover, outside of which there is a knob connected to a stem with a bolt, and the valve is provided with sealing elements wherein the head is connected to an adjusting ring. The body and the cover are made of plastics, preferably of polysulfone or polyphenylene sulfone or polyvinylidene fluoride or polyetherimide.

In some exemplary embodiments, the head and the adjusting ring connected thereto are made of plastics, preferably of polysulfone or polyphenylene sulfone or polyvinylidene fluoride or polyetherimide or polyphenylene sulphide.

In some exemplary embodiments, the head and the adjusting ring are connected by means of a threaded connection, and between the head and the adjusting ring a seal for sealing of the head is arranged. The seal may be made of ethylene-propylene-diene rubber or butadiene-acrylonitrile rubber or fluorocarbon rubber or polytetrafluoroethylene.

In exemplary embodiments, the thread of the threaded connection is formed both on the head and on the adjusting ring.

In exemplary embodiments, the threaded connection between the head and the adjusting ring is secured with a self-tapping screwed connection.

In exemplary embodiments, the body, the cover head and the adjusting ring are made by injection molding methods.

In exemplary embodiments, the stem and an aperture stop are made of plastics, preferably of polysufone or polyphenylene sulfone or polyvinylidene fluoride or polyetherimide or polyphenylene sulphide.

In exemplary embodiments the knob has markings that include a scale of full turns and tenth of turns and is made of plastics, preferably polyamide or acrylonitrile-butadiene-styrene copolymer.

In exemplary embodiments, the knob is attached to the stem with a bolt made of plastics, preferably of polysulfone or polyphenylene sulfone or polyphenylene sulphide or polyvinylidene fluoride or polyetherimide.

In exemplary embodiments, the body is provided with a Venturi tube.

In exemplary embodiments, the Venturi tube is made of plastics, preferably of polysulfone or polyphenylene sulfone or polyphenylene sulphide or polyvinylidene fluoride or polyetherimide.

In exemplary embodiments, the body is provided with measuring connector pipes and measuring valves arranged at the inlet side and an additional connector pipe arranged at the outlet side.

In exemplary embodiments, the valves are made of plastics, preferably of polysulfone or polyphenylene sulfone or polyphenylene sulphide or polyvinylidene fluoride or polyetherimide.

In exemplary embodiments, the axis of the additional connector pipe and the axes of the measuring connector pipes are arranged on the same surface.

In exemplary embodiments, sealing elements constitute sealing rings of an O-ring type.

In exemplary embodiments, sealing elements are made of ethylene-propylene-diene rubber or butadiene-acrylonitrile rubber or fluorocarbon rubber.

In exemplary embodiments, the stem, the aperture stop, the knob and the bolt are made by injection molding methods.

### BRIEF DESCRIPTION OF DRAWING

FIG. 1 presents an exemplary valve in an axial cross section.

### DETAILED DESCRIPTION

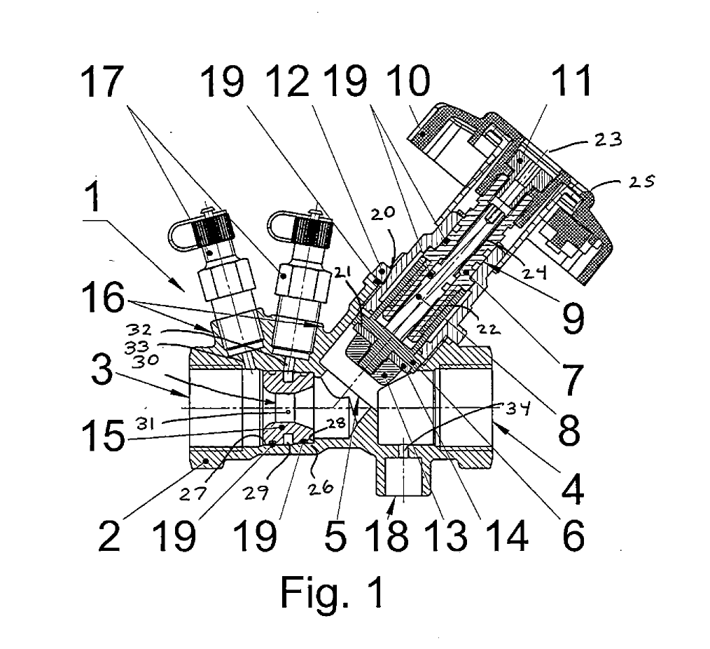

As shown in FIG. 1 an exemplary balancing valve 1 has a body 2 that has two connector pipes, namely an inlet connector pipe 3 and an outlet connector pipe 4. The body has an opening 20 that is closed with a cover 12. The cover is releasibly connected to the body 2 of the valve 1 by means of a threaded connection. In the body 2 a seat 5 is housed. The seat is closeable with a head 6 movably mounted on a stem 7. An adjusting ring 13 sized for engaging the seat is mounted to the head 6. A seal 14 extends intermediate of the head and the adjusting ring 13 and extends radially outwardly of the adjusting ring and in an annular recess 21 in the head as shown.

The body 2 of the valve 1 is made of structural plastics which in this embodiment is polysulfone being a polymer containing an —SO₂— group and an aromatic ring in the main chain. Both the body 2 and the cover 12 are made by injection molding methods, and solely some of the surfaces are subject to mechanical shaping, for example the ones where the seals are arranged or where a thread is necessary to provide a threaded connection. For example the threads 22 of the respective head 6 and stem 7 that enable movement of the head along an axis 23 responsive to relative rotational movement of the stem. Unexpectedly, it turns out that plastics, including polysulfone, exhibit good technical properties for making both the body 2 and the cover 12, because if these elements are made by injection molding methods they easily undergo mechanical shaping and maintain dimensional parameters ensuring tightness and durability of the valve. Especially significant in this case is forming in the body 2 of the seat 5 with which a head 6 and an adjusting ring 13 connected to it through a seal 14 cooperates.

Obviously, both the body 2 and the cover 12 can be made of some other plastics that meet requirements with regard to strength, stability of dimensional parameters and durability.

In other embodiments, making both the body 2 and the cover 12 of polyphenylene sulfone, polyvinylidene fluoride and polyetherimide have been used. These materials exhibit appropriate mechanical properties.

Inside the stem 7 is an axially extending stem opening 24. An aperture stop 8 extends in the stem opening 24 and extends axially outward therefrom as shown. The aperture stop is arranged to stop opening movement along the axis away from the seat by engagement of the head 6. The stem 7 is seated in a gland 9 and terminates at the opposite side of the head 6 in connection with a knob 10. The knob 10 is rotated to open and close the valve 1. The head 6 together with the stem 7 and the gland are seated in the cover 12 that closes the opening 20 above the seat 5 in the body 2 of the valve 1.

The exemplary head 6 and the adjusting ring 13 are made of structural plastics.

In this exemplary embodiment, the plastics for the head 6 and the adjusting ring 13 is polysulfone which is a polymer containing an —SO₂— group and an aromatic ring in the main chain. Both the head 6 and the adjusting ring 13 are made by injection molding methods and basically the surfaces where a seal is seated are subject to mechanical shaping, for example a seal where the head 6 cooperates with the seat 5 or where a thread is necessary for providing a threaded connection.

Similarly as in the case of the body 2 and the cover 12, the head 6 and the adjusting ring 13 can be made in other embodiments of some other plastics such as: polyphenylene sulfone, polyvinylidene fluoride, polyetherimide and polyphenylene sulphide. These materials exhibit appropriate mechanical properties.

The exemplary head 6 is connected to the exemplary adjusting ring 13 in an axial alignment at the side of the seat 5 of the valve 1 as shown. The connection of the head 6 with the adjusting ring 13 is a releasible threaded connection wherein an external thread is formed on the head 6, and an internal thread is formed in the adjusting ring 13. Between portions of the head 6 and the adjusting ring 13, a resilient annual seal 14 of the head 6 is positioned. The exemplary seal is arranged with a flat cross-section and seated on one side on the surface of the adjusting ring 13, and on the other side in the annular recess 21 on the front surface of the head 6. During making the connection of the head 6 to the adjusting ring 13, the axial position of the seal 14 of the head 6 becomes fixed through the threaded connection. In an exemplary embodiment once the head 6 is connected to the adjusting ring 13 the threaded connection is locked by screwing a self-tapping screw (not shown) in.

The exemplary seal 13 of the head 6 in this exemplary embodiment is made of ethylene-propylene-diene rubber, however in other embodiments such materials as butadiene-acrylonitrile rubber, fluorocarbon rubber or polytetrafluoroethylene can be used.

The stem 7 and the aperture stop 8 arranged therein in exemplary embodiments are also made of plastics. In this exemplary embodiment the material for both the stem 7 and the aperture stop 8 is polysulfone. However, also in other embodiments other materials with similar properties can be used, such as polyphenylene sulfone, polyvinylidene fluoride, polyetherimide or polyphenylene sulfides.

The exemplary knob 10 has visible markings on at least one marking surface 25 thereof that includes a scale of full turns and tenths of turns. The exemplary knob is made of plastics. In this exemplary embodiment the material is polyamide, however in other embodiments other materials, such as acrylonitrile-butadiene-styrene copolymer, can be used.

The bolt 11 with which the knob 10 is attached in screwed connection to the stem 7 is made of plastics, which in this embodiment is polysulfone. Other plastics materials for the bolt 11 can be polyphenylene sulfone, polyphenylene sulfide, polyvinylidene fluoride or polyetherimide.

The body 2 of the valve 1 on the side of the inlet connector pipe 3 is provided with a Venturi tube piece 15 intended for measuring pressure at selected points of the valve 1 and determining instantaneous flow of the fluid inside the valve 1.

The Venturi tube piece 15 of exemplary embodiments is made of plastics which in an exemplary embodiment is polysulfone. In other embodiments, the Venturi tube piece 15 can be made of polyphenylene sulfone, polyphenylene sulphide, polyvinylidene fluoride or polyetherimide.

As shown in FIG. 1, the exemplary Venturi tube piece 15 is slidably releasibly positionable in an annular section 26 within the fluid flow path within the body 2. The annular section 26 is bounded by an annular section wall 27 which terminates in a radially inwardly extending lip 28 as shown. The Venturi tube piece 15 of the exemplary embodiment includes an annular recess 29 that extends radially inwardly from the outer annular surface of the Venturi tube piece. In the operative position the annular recess 29 is bounded inwardly by the Venturi tube piece 15 and outwardly by the annular section wall 27. Resilient sealing elements 19 extend between the annular wall 27 and the Venturi tube piece on opposed sides of the annular recess 29.

The Venturi tube piece 15 includes a constricted interior opening 30 therethrough. Fluid passing through the valve from the inlet connector pipe 3 to the outlet connector pipe 4 is required to pass through the constricted interior opening 30. The constricted interior opening 30 of the Venturi tube piece 15 includes an opening 31 as shown. The opening 31 is connected to the annular recess 29 and to a pressure test connector opening 32 through the body of the valve. Also as shown, an upstream pressure test connector opening 33 extends in the valve into an upstream fluid passage portion that is positioned between the Venturi tube piece 15 and the inlet connector pipe 3. Also as shown, a pressure test downstream connector opening 34 extends through the body in a downstream fluid passage that is positioned between the outlet connector pipe 4 and the valve seat 5. Each of the pressure test connector openings 32, 33 and 34 is in operative connection with a respective connector pipe 16 on the valve body 2.

The body 2 of the valve 1 on the inlet connector pipe 3 side of the seat is provided with the measuring connector pipes 16 in which measuring valves 17 are seated. The measuring valves are in cooperating relation with the pressure test upstream connector opening 33 and the pressure test connector opening 32 which is connected to the opening 31 in the Venturi tube piece 15. The body 2 of the valve 1 on the outlet connector pipe 4 side of the seat has the downstream connector opening 34 provided with an additional connector pipe 18.

The exemplary measuring valves 17 are made of plastics. In this embodiment the measuring valves 17 are made of polysulfone, however in other embodiments they can be made of polyphenylene sulfone, polyphenylene sulphide, polyvinylidene fluoride or polyetherimide.

The valve 1, where needed specifically, and in particular at connections or contact areas of individual elements, is equipped with sealing elements 19 which in this embodiment constitute resilient sealing rings of an O-ring type. The sealing elements 19 in this exemplary embodiment are made of ethylene-propylene-diene rubber, however in other embodiments other materials, such as butadiene-acrylonitrile rubber or fluorocarbon rubber can be used.

The exemplary balancing value features can be executed in many different embodiments without departing from its relevant subject-matter, and therefore also in such arrangement when the body 2 and the cover 12 are made of plastics and the other elements or some selected elements are made of metal.

Embodiments of the balancing valve 1 may achieve several goals simultaneously. Such embodiments may contribute to reduction of production costs and improves corrosion resistance of the components of the valve 1, while, due to the properties of the material used to make the head 6 and the adjusting ring 13, it allows for self-adjustment of matching of the head 6 with the adjusting ring 13 to the seat 5 of the valve resulting from the flexibility of the plastics. At the same time, it allows smooth and highly accurate adjustment of the flow parameters of fluid flow through the valve by selective rotational movement of the knob 10 axially positioning the adjusting ring 13 relative to the seat 5 in the manner shown in the drawing.

In the foregoing description, certain terms have been used to describe exemplary embodiments for purposes of brevity, clarity and understanding. However, no unnecessary limitations are to be implied therefrom because such terms are used for descriptive purposes and are intended to be broadly construed. Moreover the descriptions and illustrations herein are by way of examples, and embodiments are not limited to the exact features shown or described.

Further in the following claims any feature described as a means for performing a function shall be construed as encompassing any means known to those skilled in the art as being capable of carrying out the recited function and shall not be deemed limited to the particular means shown or described for performing the recited function in the foregoing description or mere equivalents thereof.

Having described the features, discoveries and principles of the exemplary arrangements, the manner in which they are constructed and operated, and the advantages and useful results attained, the new and useful structures, devices, elements, arrangements, parts, combinations, systems, equipment, operations, methods, processes and relationships are set forth in the appended claims.

1-53. (canceled)

54. A balancing valve, comprising
a body including
an inlet connector pipe,
an outlet connector pipe,
a valve seat within the body and fluidly intermediate within the body of the inlet and outlet connector pipes,
wherein the valve seat is configured such that fluid from the inlet connector pipe flows through the seat to reach the outlet connector pipe,
an opening through the body, wherein the valve seat underlies the opening,
a cover in releasible engagement with the body, wherein the cover is configured to fluidly close the opening,
a stem, wherein the stem is movably mounted in operatively supported connection with the cover, wherein the stem is rotatable about an axis,
a rotatable knob external of the body, wherein the rotatable knob is in operative connection with the stem,
wherein the stem is axially movable relative to the cover responsive to rotation of the knob,
a head in operative connection with the stem,
an adjusting ring, wherein the adjusting ring is in operative connection with the head,
wherein the head and the adjusting ring are operative to axially move within the body of the valve relative to the valve seat, wherein the axial position of the head and the adjusting ring relative to the seat is operative to selectively provide variable controlled fluid flow and to block fluid flow through the valve seat,
wherein the body and the cover are each comprised of plastic.

55. The valve according to claim 54 wherein the body and the cover are each comprised of at least one of
polysulfone,
polyphenylene sulfone,
polyvinylidene fluoride, and
polyetherimide.

56. The valve according to claim 54
wherein the head is in threaded operative connected engagement with the stem, wherein relative rotational movement of the stem relative to the head responsive to movement of the knob is operative to cause axial movement of the head and the adjusting ring,
wherein the head and the adjusting ring are comprised of plastic.

57. The valve according to claim 56 wherein the head and the adjusting ring are each comprised of at least one of
polysulfone,
polyphenylene sulfone,
polyvinylidene fluoride,
polyetherimide, and
polyphenylene sulphide.

58. The valve according to claim 54,
wherein the adjusting ring is releasibly engageable with the head via a threaded connection,
an annular seal comprised of a resilient material, wherein the seal is in axially intermediate relation between at least a portion of the adjusting ring and a portion of the head.

59. The valve according to claim 54
wherein the adjusting ring is releasibly engageable with the head via a threaded connection,
an annular seal comprised of a resilient material, wherein the seal is in axially intermediate relation between at least a portion of the adjusting ring and a portion of the head, and wherein the seal extends annularly and radially outwardly relative to the adjusting ring.

60. The valve according to claim 54
wherein the adjusting ring is releasibly engageable with the head via a threaded connection,
an annular seal comprised of a resilient material, wherein the seal is in axially intermediate relation between at least a portion of the adjusting ring and a portion of the head,
wherein the head includes an annular recess, and wherein the resilient seal extends in the annular recess.

61. The valve according to claim 54
wherein the adjusting ring is releasibly engageable with the head via a threaded connection,
an annular seal comprised of a resilient material, wherein the seal is in axially intermediate relation between at least a portion of the adjusting ring and a portion of the head,
wherein the cover, the head and the adjusting ring are each comprised of plastic formed via an injection molding process.

62. The valve according to claim 54
wherein the adjusting ring is releasibly engageable with the head via a threaded connection,
an annular seal comprised of a resilient material, wherein the seal is in axially intermediate relation between at least a portion of the adjusting ring and a portion of the head,
wherein the resilient material comprises at least one of
butadiene-acrylonitrile rubber,
fluorocarbon rubber, and
polytetrafluoroethylene.

63. The valve according to claim 54
wherein the stem includes an axially extending stem opening,
an aperture stop, wherein the aperture stop extends in the stem opening and extends axially outward therefrom in a direction toward the valve seat,
wherein the aperture stop is configured to operatively engage the head to limit movement of the head and the adjusting ring in an axial direction away from the valve seat,
wherein the stem and the aperture stop are each comprised of plastic.

64. The valve according to claim 63 wherein each of the stem and the aperture stop are comprised of at least one of
polysulfone,
polyphenylene sulfone,
polyvinylidene fluoride,
polyetherimide, and
polyphenylene sulphide.

65. The valve according to claim 54
wherein the knob includes scale markings thereon, wherein the scale markings include markings corresponding to one-tenth turns and full turns,
wherein the knob is comprised of plastic.

66. The valve according to claim 65 wherein the knob comprises at least one of
polyamide, and
acrylonitrile-butadiene-styrene copolymer.

67. The valve according to claim 54
and further comprising a bolt, wherein the bolt holds the knob and the stem in operatively engaged relation,
wherein the bolt is comprised of plastic.

68. The valve according to claim 67 wherein the bolt is comprised of at least one of
polysulfone,
polyphenylene sulfone,
polyphenylene sulphide,
polyvinylidene fluoride, and
polyetherimide.

69. The valve according to claim 54
wherein the body includes an internal annular section, wherein the annular section is fluidly intermediate of the inlet connector pipe and the valve seat,
an annular venturi tube piece, wherein the venturi tube piece includes a constricted interior opening through which fluid flowing through the valve between the inlet connector pipe and the outlet connector pipe is required to pass,
wherein the annular venturi tube piece is releasibly positionable in the annular section.

70. The valve according to claim 69 wherein the venturi tube piece is comprised of at least one of
polysulfone,
polyphenylene sulfone,
polyphenylene sulphide,
polyvinylidene fluoride, and
polyetherimide.

71. The valve according to claim 54
wherein the body includes an internal annular section, wherein the annular section is fluidly intermediate of the inlet connector pipe and the valve seat and is bounded by an annular section wall,
an annular venturi tube piece, wherein the venturi tube piece includes a constricted interior opening through which fluid flowing through the valve between the inlet connector pipe and the outlet connector pipe is required to pass,
wherein the annular venturi tube piece is releasibly positionable in the annular section,
wherein the venturi tube piece includes
an annular recess that extends radially inwardly about an annular exterior surface of the Venturi tube piece and is bounded radially inwardly by the venturi tube piece, and when positioned in the annular section the annular recess is bounded radially outwardly by the annular section wall,
at least one opening extending radially between the constricted interior opening and the annular recess,
a pressure test connector opening through the body and the annular section wall, wherein the pressure test connector opening is in fluid connection with the annular recess.

72. The valve according to claim 71
and further comprising:
a pressure test upstream connector opening, wherein the pressure test upstream connector opening extends through the body and is in operative connection with an upstream fluid passage fluidly intermediate of the venturi tube piece and the inlet connector pipe,
a pressure test downstream connector opening, wherein the pressure test downstream connector opening extends through the body and is in operative connection with a downstream fluid passage intermediate of the valve seat and the outlet connector pipe.

73. The valve according to claim 72
wherein each of the
pressure test connector opening,
pressure test upstream connector opening,
pressure downstream connector opening,
is operatively connected to a respective plastic connector pipe in operative connection with the body.
